(19) United States
(12) Patent Application Publication
(10) Pub. No.: US 2022/0032508 A1
(43) Pub. Date: Feb. 3, 2022

(54) BREAKABLE THREE DIMENSIONAL (3D) PRINTED MOLDS

(71) Applicant: Hewlett-Packard Development Company, L.P., Spring, TX (US)

(72) Inventors: Wei Huang, Palo Alto, CA (US); Gary J Dispoto, Palo Alto, CA (US)

(73) Assignee: Hewlett-Packard Development Company, L.P., Spring, TX (US)

(21) Appl. No.: 17/299,651

(22) PCT Filed: Dec. 17, 2018
(86) PCT No.: PCT/US2018/066015

§ 371 Date: Jun. 3, 2021

(51) Int. Cl. B29C 33/44; B29C 64/165; B29C 64/393; B22F 10/10; B22F 3/11; B22F 5/00

(52) U.S. Cl. CPC B29C 33/448; B29C 64/165; B29C 64/393; B33Y 10/00; B22F 3/11; B22F 5/007; B22F 10/10

(57) ABSTRACT

Breakable three dimensional (3D) printed molds are disclosed. An example method for forming a mold having a cavity by creating a plurality of layers using an additive manufacturing process includes providing a build material; and controlling a fusion level of the build material separately for different layers of the plurality of layers to separately form the layers with a porosity corresponding to a target porosity.

### BACKGROUND

In three-dimensional (3D) printing, an additive printing process is often used to make three-dimensional solid parts from a digital model. 3D printing can be used in rapid product prototyping, mold generation, mold master generation, and short run manufacturing.

### BRIEF DESCRIPTION OF THE DRAWINGS

FIG. 1 is a block diagram an example workstation 100 that can be employed to manufacture a 3D printed mold in accordance with teachings of this disclosure.

FIG. 2 is a schematic illustration of an example process for forming the example 3D printed mold via the example workstation of FIG. 1.

FIG. 3 is a plan view of an example first layer of the example 3D printed mold of FIGS. 1 and 2.

FIG. 4 illustrates an example layer of the example 3D printed mold of FIGS. 1-3 formed with a first porosity via an example contone-level control approach.

FIG. 5 illustrates another example layer of another example 3D printed mold having a second porosity that is different than the first porosity of the example 3D printed mold of FIG. 4.

FIG. 6 illustrates an example layer of the example 3D printed mold of FIGS. 1-3 formed with a third porosity via an example heat transfer control approach.

FIG. 7 is a top, perspective view of an example 3D printed mold that can implement the example 3D printed mold of FIGS. 1-6.

FIG. 8 is a top, perspective view of the example 3D printed mold of FIG. 7 filled with an example moldable material to form an example molded part.

FIG. 9A is a top, perspective view and FIG. 9B is a side view of an example molded part formed by the example 3D printed mold of FIGS. 7 and 9.

FIG. 10 illustrates the example 3D printed mold separated into a plurality of segments.

FIG. 11A is a top, perspective view of another example 3D printed mold that can implement the 3D printed mold of FIGS. 1-6.

FIG. 11B is a cross-sectional view of the example 3D printed mold of FIG. 11A.

FIG. 12A is an example molded part formed via the example 3D printed mold of FIGS. 11A and 11B.

FIG. 12B is a cross-sectional view of the example molded part of FIG. 12A.

FIGS. 13-14 are flowcharts illustrating example methods of forming 3D printed molds disclosed herein.

FIG. 15 is a block diagram of an example processing platform structured to execute instructions of FIGS. 13-14 to implement the example workstation of FIG. 1.

Where ever possible the same reference numbers are used throughout the drawing(s) and accompanying written description to refer to the same or like parts. The figures are not necessarily to scale and certain features and certain views of the figures can be shown exaggerated in scale or in schematic for clarity and/or conciseness. Additionally, several examples have been described throughout this specification. Any features from any example can be included with, a replacement for, or otherwise combined with other features from other examples.

### DETAILED DESCRIPTION

Certain examples are shown in the identified figures and disclosed in detail herein. Although the following discloses example methods and apparatus, it should be noted that such methods and apparatus are merely illustrative and should not be considered as limiting the scope of this disclosure.

As used herein, directional terms, such as “upper,” “lower,” “top,” “bottom,” “front,” “back,” “leading,” “trailing,” “left,” “right,” etc. are used with reference to the orientation of the figures being described. Because components of various examples disclosed herein can be positioned in a number of different orientations, the directional terminology is used for illustrative purposes and is not intended to be limiting.

Additive manufacturing processes can be used to manufacture parts having complex geometries. However, parts manufactured via additive printing processes are often limited to a small section of materials (e.g., 3D printable materials). For example, a small portion of polymer materials in the manufacturing industry can be used as 3D printing material(s). Thus, material availability has been a significant limitation for 3D printing processes compared to other manufacturing processes. Additionally, additive manufacturing processes can be expensive and/or can be time consuming process. In some instances, 3D printed parts can have relatively weak strength (e.g., mechanical strength, stress or strain characteristic(s)) compared to, for example, machined parts or molded parts. Other manufacturing processes employing molds are compatible with many different types of materials (e.g., thermoplastic and thermosetting polymer materials, etc.). However, such manufacturing processes employing molds are limited to the production of simple geometries because complex parts cannot be separated from the molds.

Examples disclosed herein provide methods for manufacturing molds having complex geometries via additive manufacturing processes (e.g., 3D printed molds). For example, 3D printing techniques or processes are considered additive processes because the 3D printing processes involve the application of successive layers of material. Example 3D printing processes involve curing or fusing of a building material, which can be accomplished using heat-assisted extrusion, melting, sintering, digital light projection technology, etc. For example, 3D printed objects can be printed using, for example, a multi-jet fusion (MJF) process. MJF is a powder-based technology. A powder bed is heated uniformly at the outset. A fusing agent is jetted where particles need to be selectively molten, and a detailing agent is jetted around the contours to improve part resolution and/or improve temperature distribution (e.g., across a build material) to control a porosity of a 3D printed mold. While lamps pass over a surface of the powder bed, the jetted material captures the heat and helps distribute the heat evenly.

In some examples disclosed herein, 3D printed molds can be manufactured via MJF technology. The 3D printed molds are then employed in other manufacturing processes such as, for example, injection molding, casting etc., to manufacture parts using non-3D printable materials. After formation of the 3D printed mold, a moldable material can be provided in a cavity of the 3D printed mold. As used herein, a “moldable material” is any material such as, for example, a liquid, a powder, clay, etc., that becomes liquid or malleable when heated (e.g., to a temperature of 150 degrees Fahrenheit (° F.)) and solidifies when cooled (e.g., to room temperature). For example, the moldable material can be, for example, a liquid or a powder, a polymer, a molten material, a liquid polymer, a polymer mixed with metal or ceramics, a low-temperature metal, thermosetting material(s) such as resigns that can be cured (e.g., UV cured) to solidify after molding, and/or any other suitable material(s). The moldable material can then be treated (e.g., cooled, cured, etc.) for solidification. After solidification of the molded material, the mold can be separated (e.g., destroyed and removed) from the molded part. Thus, the example 3D printed molds disclosed herein can be single use molds that can be broken down and removed from a molded part after formation of the molded part.

In 3D printing processes, full solidification of materials has always been desired for highest mechanical strength possible. For example, in thermal powder bed-based 3D printing processes, such as MJF for plastic materials, process parameters are optimized to avoid under-fused powder to form fully dense parts (e.g., parts having 0% to 1% porosity). As used herein, “porosity” means a measure of void (i.e. “empty”) spaces in a material. In some examples, porosity is determined as a fraction of a volume of voids over a total volume, or as a ratio of a volume of interstices of a material to a volume of its mass. A degree of fusion in powder bed-based 3D printing processes affects resulting material properties such as, for example, Young's modulus, ultimate strain and stress, etc. Therefore, printing a 3D part with an under-fused polymer powder can present mechanical strength properties that differ from (e.g., are inferior to) mechanical strength properties of a fully-fused polymer powder.

To facilitate separation of a mold from a molded part, example 3D printed molds disclosed herein can be formed with under-fused polymer powder during the 3D printing process. For example, to form a 3D printed mold having under-fused layers, a level of fusion of each layer of the 3D printed mold is varied during a 3D printing process. As used herein, a level of fusion refers to controlling an amount of fusing agent and/or an amount of heat to be received by a build material to affect or control an amount of melt of particles to be selectively molten. As a result, example systems and methods disclosed herein control a porosity of a 3D printed mold when forming the 3D printed mold using additive manufacturing process(es). For example, forming 3D printed molds disclosed herein with under-fused powder decreases a mechanical strength of the 3D printed mold compared to a mechanical strength of a 3D printed mold formed from a fully-fused powder. Therefore, the mold can be formed with a smaller mechanical strength characteristics to facilitate removal of the 3D printed mold from a molded part. As a result, the 3D printed mold has sufficient strength to maintain its shape during a molding process but can be broken down (e.g., destroyed) after formation of the molded part using, for example a tool (e.g., a hammer).

To form a 3D printed mold disclosed herein with a varying or controlled-degree of porosity (e.g., a porosity between 20 percent and 30 percent) and/or a level a fusion of each layer, the examples disclosed herein vary a fusing agent (e.g., MJF process), a detailing agent (e.g., a cooling agent), an energy level (e.g. SLS process), a binder agent (e.g., 3D binder jetting), etc. during the printing process.

For example, to control fusion levels and/or vary (e.g., increase) a porosity during an MJF 3D printing process, examples disclosed herein employ (1) a contone level-controlled approach or (2) a heat transfer-controlled approach. In the contone level-controlled approach, a volume (e.g., an amount) of fusing agents can be applied to each layer of the 3D printed part (e.g., under-fused layers) at lower contone levels to vary (e.g. increase) a porosity of each 3D printed layer. The desired fusing degree of the under-fused layer can be achieved by the corresponding contone level.

To vary porosity and/or fusing level characteristics during a selective laser sintering (SLS) process, examples disclosed vary an energy provided to a build material during the SLS process. For example, an SLS process employs a laser that provides energy sufficient to cause particles of a build material to fuse together and form a solid structure. Thus, to vary the porosity, a lower amount of energy (e.g., a first amount of heat) can be provided to a layer of a 3D printed mold that is less than an energy level needed to fully-fuse the layer.

Example disclosed herein can be employed with 3D binder jetting processes. For example, 3D binder jetting is an additive manufacturing process that forms 3D printed parts or molds additively with a binding agent. In some examples, the 3D binder jetting process uses a liquid binding agent deposited on a metal powder material, layer by layer, according to a 3D model. In some such examples, a porosity of a 3D printed mold can be varied by adjusting or varying an amount of at least one of the binder agent or an energy applied to a build material and the binder agent.

In some examples, the example methods disclosed herein can employ a detailing agent (e.g., a cooling agent) to vary a porosity of a 3D printed mold. The detailing agent maintains a temperature of a build material cooler than a temperature of a build material that does not have the detailing agent to reduce or prevent the effects of thermal bleed between the build layer and, thereby, control (e.g., increase) a porosity of the build layer. Thus, although the example disclosed herein are discussed in connection with MJF process, the examples can be implemented with SLS processes, 3D binder jetting processes, and/or any other additive manufacturing process(es).

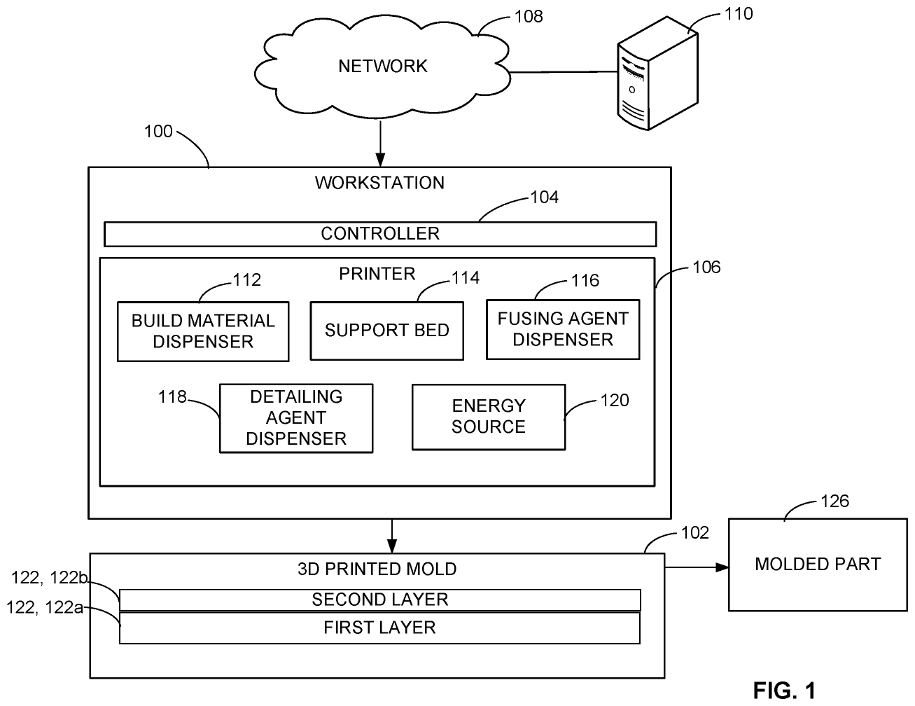

Turning more specifically to the illustrated examples, FIG. 1 depicts an example workstation 100 that can be employed to manufacture a 3D printed mold 102 in accordance with teachings of this disclosure. The workstation 100 of the illustrated example employs MJF technology to fabricate the 3D printed mold 102. The 3D printed mold 102 may be formed through an MJF process where powder particles are fused (e.g., under-fused or partially fused) together through application of a fusing agent and heat. In some examples, the workstation 100 can be a Jet Fusion 4200 series 3D printer manufactured by HP, Inc. The 3D printed mold 102 can be composed of material(s) including, for example, polymers or a mixture of polymer and metal/ceramic material(s) including, but not limited to, nylons (e.g., nylon 12, nylon 11, nylon 6, etc.), polypropylenes, polyethylene, thermoplastic polyurethane and/or any other semi-crystalline thermoplastic(s) and/or polymer material(s).

The workstation 100 includes an example controller 104 and an example printer 106 (e.g., a 3D printer). The controller 104 may be a computing device, a semiconductor-based microprocessor, a central processing unit (CPU), an application specific integrated circuit (ASIC), and/or other hardware processing device. The controller 104 can be communicatively coupled to an example computing device 110 (e.g., a desktop, a server, etc.) via an example network 108 (e.g., a wireless network, a wired network, etc.). For example, the computing device 110 may be a computer that sends instructions to the controller 104 to print or produce the 3D printed mold 102. While an example network topology is shown in FIG. 1, any appropriate network topology may be implemented.

The printer 106 of the illustrated example includes an example build material dispenser 112, an example support bed 114, an example fusing agent dispenser 116, an example detailing agent dispenser 118, and an example energy source 120. The build material dispenser 112, the fusing agent dispenser 116, and/or the detailing agent dispenser 118 can be piezo dispensers, thermal inject cartridges or print heads, and/or any other dispenser or inkjet cartridge(s) or print heads that eject material(s) during a printing process. The energy source 120 can be, for example, a laser, infrared light, ultraviolet light, a heat lamp, a heating element, and/or can be any other source that produces heat.

In operation, the workstation 100 of the illustrated example can: (1) receive a digital image that includes an identifier corresponding to a target porosity of the 3D printed mold 102, or (2) modify a digital file with a target porosity received via an input command (e.g., a user interface). Based on the digital file and the target porosity, the controller 104 determines an amount of build material, fusing agent and/or energy needed to form the 3D printed mold 102 in accordance with a pattern associated 3D printed mold 102 and/or a target porosity of the 3D printed mold 102. For example, the controller 104 causes the build material dispenser 112 to dispense a volume of building material, the fusing agent dispenser 116 to dispense a volume of the fusing agent, the detailing agent dispenser 118 to dispense a volume of the detailing agent and/or the energy source 120 to generate energy in accordance with the targeted porosity. In some examples, the workstation 100 receives information (e.g., a file) including an amount of fusing agent, an amount of the detailing agent and/or an amount of the energy level to be applied to achieve a target porosity and the controller 104 controls the dispensing of the fusing agent, the detailing agent and/or the amount of energy to be applied based on the received information. For example, in some examples the workstation 100 receives the target porosity and/or instructions from the computing device 110. For example, the computing device 110 can provide information to the workstation 100 regarding a volume of building material to be dispensed by the build material dispenser 112, a volume of the fusing agent to be dispensed by the fusing agent dispenser 116, a volume of the detailing agent to be dispensed by the detailing agent dispenser 118, and/or an amount of energy to be provided by the energy source 120 to generate the 3D printed part 102 in accordance with the targeted porosity.

The printer 106 of the illustrated example produces the 3D printed mold 102 by building a plurality of layers 122 (e.g., vertical layers). For example, a first layer 122a of the 3D printed mold 102 aligns with a second layer 122b. The first and second layers 122a of the illustrated example are formed with a porosity between approximately 2% and 45% (e.g., between 20% and 30%) based on the target porosity determined and/or received by the controller 104. In some examples, the second layer 122b is formed with a porosity that is similar or identical to a porosity of the first layer 122a. For example, in some instances, the porosities of the first and second layers 122a, 122b vary due to manufacturing tolerances when a target porosity of the first layer 122a input to the controller 104 is the identical to a target porosity of the second layer 122b input to the controller 104. For example, the first porosity of the first layer 122a can be within a percentage (e.g., between approximately 1 percent and 5 percent) of a porosity of the second layer 122b.

As a result of the controlling the porosities by forming the layers 122 of the 3D printed mold 102 as under-fused (e.g. partially-fused) layers, the 3D printed mold 102 has mechanical strength characteristic(s) (e.g., ultimate strain and stress, impact resistance, etc.) that is different than (e.g., less than) mechanical strength characteristic(s) (e.g., ultimate strain and stress, impact resistance) of a fully-fused 3D printed mold. For example, when the 3D printed mold 102 is composed of nylon 12, the 3D printed mold 102 (e.g., a partially-fused 3D printed mold) can have an ultimate stress characteristic of between approximately 5 megapascal (MPa) and 20 MPa (e.g., 10 MPa). In contrast, a fully-fused 3D printed mold can have an ultimate stress characteristic of between approximately 80 MPa and 120 MPa (e.g., 100 MPa). To this end, the 3D printed mold 102 enables or facilities separation of the 3D printed mold 102 into multiple segments or structures after formation of the molded part 126. Thus, a force imparted to the 3D printed mold 102 causes the 3D printed mold 102 to break or separate and removed from the molded part 126.

To control a level of fusion of the layers 122 of the 3D printed mold 102, the examples disclosed herein control a temperature or heat absorption of a build material during printing of the 3D printed mold 102. For example, by controlling a temperature or heat absorption of the build material, the porosity can be controlled (e.g., substantially homogeneously) across an entire surface area or volume of the first layer 122a, the second layer 122b, etc. To control the temperature of a build material of the layers 122 during printing process and control (e.g., increase) the porosity of the 3D printed mold 102, examples disclosed herein include controlling at least one of: (1) a contone level of a fusing agent; or (2) a heat transfer during the printing process.

After formation of the 3D printed mold 102, the 3D printed mold 102 can be used to form a molded part 126 via other molding (e.g., casting) manufacturing processes. After the molded part 126 solidifies in the 3D printed mold 102, the 3D printed mold 102 is removed from the molded part 126 by separating the 3D printed mold 102 into multiple segments or pieces. The pieces of the 3D printed mold 102 are removed from the molded part 126.

The examples disclosed herein are not limited to MJF process. For example, the workstation 100 can be configured to implement any other suitable additive manufacturing processes. In some examples, the examples disclosed herein can employ a detailing agent process, a selective laser sintering (SLS), or a 3D binder jetting process to control a porosity of the 3D printed mold 102.

To implement a detailing agent process, the workstation 100 of FIG.1 can be configured to dispense a detailing agent (e.g., water, a cooling agent, etc.) to control a temperature of the layers 122. For example, the controller 104 can cause the detailing agent dispenser 118 to dispense a detailing agent (e.g., a liquid, water, etc.) on a build material on the layers 122. During a fusing process of the 3D printed mold 102 that occurs during a printing process, the detailing agent maintains a temperature of the building material cooler than the fusing agent disposed on the build material to enable a lesser amount of heat or energy absorption and cause the build material (e.g., the first layer 122a) to be under-fused.

Alternatively, in some examples, the workstation 100 can be configured to implement a selective laser sintering (SLS) apparatus or process. In some such examples, the energy source 120 can be a laser that applies energy to a build material provided by the build material dispenser 112. To vary a porosity of a 3D printed mold, the energy source 120 varies an amount of energy provided to (e.g., a layer of) the 3D printed mold. In some such examples, the workstation 100 does not include the fusing agent dispenser 116 and the detailing agent dispenser 118.

In some examples, the workstation 100 can be configured to implement a 3D binder jetting process. For example, the printer 106 can include a binder agent dispenser instead of the fusing agent dispenser 116 and the detailing agent dispenser 118. To vary a porosity of a 3D printed mold, the printer 106 can vary at least one of a binder agent provided to a build material or an amount of energy provided to the binder agent and the build material.

The example 3D printed mold 102 does not include any inserts or structures (e.g., metal inserts) to define or enable the breakaway feature. The breakaway feature is enabled by the porosity or fusion level of the 3D printed mold 102 that is controlled during printing (e.g., an MJF printing process, an SLS printing process, a 3D binder jetting process, etc.) of the 3D printed mold 102.

While an example manner of implementing the workstation 100 is illustrated in FIG. 1, any or some the elements, processes, and/or devices illustrated in FIG. 1 may be combined, divided, re-arranged, omitted, eliminated, and/or implemented in any other way. Further, the example controller 104, the example printer 106, the example build material dispenser 112, the example support bed 114, the example fusing agent dispenser 116, the example detailing agent dispenser 118, the example energy source 120 and/or, more generally, the example workstation 100 of FIG. 1 may be implemented by hardware or machine readable instructions including, for example, software or firmware, and/or implemented by any combination of hardware, software and/or firmware. Thus, for example, any of the example controller 104, the example printer 106, the example build material dispenser 112, the example support bed 114, the example fusing agent dispenser 116, the example detailing agent dispenser 118, the example energy source 120 and/or, more generally, the example workstation 100 of FIG. 1 could be implemented by analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)). When reading any of the apparatus or system claims of this patent to cover an implementation of purely machine readable instructions, at least one of the example controller 104, the example printer 106, the example build material dispenser 112, the example support bed 114, the example fusing agent dispenser 116, the example detailing agent dispenser 118, the example energy source 120, and/or, more generally, the example workstation 100 of FIG. 1 is/are hereby expressly defined to include a non-transitory computer readable storage device or storage disk such as a memory, a digital versatile disk (DVD), a compact disk (CD), a Blu-ray disk, etc. including the software and/or firmware (e.g., machine readable instructions). Further still, the example workstation 100 of FIG. 1 may include other element(s), process(es), and/or device(s) in addition to, or instead of, those illustrated in FIG. 1, and/or may include more than one of any or all of the illustrated elements, processes, and devices. As used herein, the phrase “in communication,” including variations thereof, encompasses direct communication and/or indirect communication through intermediary component(s), and does not require direct physical (e.g., wired) communication and/or constant communication, but rather additionally includes selective communication at periodic intervals, scheduled intervals, aperiodic intervals, and/or one-time events.

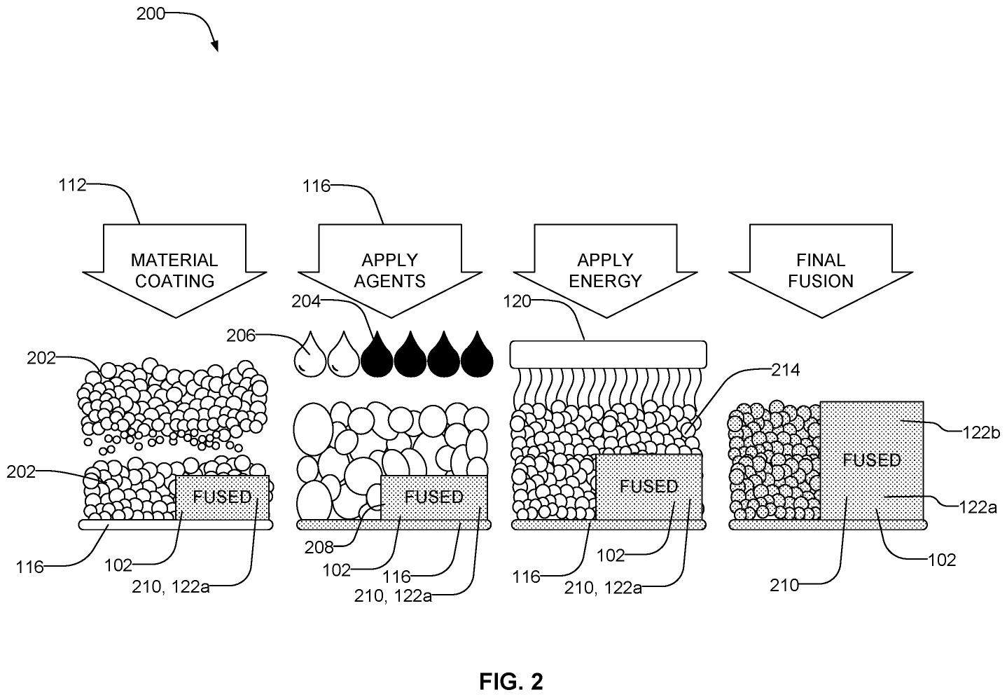

FIG. 2 is a schematic illustration of an example additive manufacturing process 200 (e.g., an MJF process) for forming the 3D printed mold 102 via the workstation 100 of FIG. 1. To form the 3D printed mold 102, the controller 104 receives instructions (e.g., via the computing device 110 and/or the example network 108) to fabricate the 3D printed mold 102. For example, the controller 104 can receive instructions via a digital file (e.g., a STEP file, a computer-aided design (CAD) file) representative of the 3D printed mold 102 that includes a target porosity (e.g., 25%). The controller 104 of the illustrated example causes the build material dispenser 112, the fusing agent dispenser 116, the detailing agent dispenser 118, and the energy source 120 to move along a pre-determined pattern relative to the support bed 114 to generate or build the 3D printed mold 102 with a porosity in accordance with the target porosity.

To produce the 3D printed mold 102, the controller 104 causes the build material dispenser 112 to dispense a build material 202 on the support bed 114 (e.g., a powder bed-based 3D printing processes). The build material 202 is a powder based material (e.g., nylon powder). In some examples, the build material dispenser 112 dispenses or deposits the build material uniformly across (e.g., an entire) working area of the support bed 114. To facilitate fusion (e.g., solidification) of the build material 202, the fusing agent dispenser 116 dispenses a fusing agent 204 (e.g., an agent) on the build material 202. Specifically, the fusing agent 204 is jetted on the build material 202 at locations or regions where particles of the build material 202 are to be selectively molten or fused together. To generate a pattern corresponding to the 3D printed mold 102, the controller 104 of the illustrated example controls dispensing the fusing agent 204 at specific locations relative to the build material 202 via the fusing agent dispenser 116. In some examples, a detailing agent 206 is jetted (e.g., via the detailing agent dispenser 118) around the contours of fused portions of the 3D printed mold 102 to improve part resolution. In some examples, the detailing agent 206 is provided at peripheral or terminating edge 208 of the 3D printed mold 102. In contrast to the fusing agent 204, the detailing agent 206 reduces or prevents fusion or solidification of the build material 202. In some examples, the detailing agent 206 is provided on the build material 202 and/or the fusing agent 204 to improve heat transfer and/or heat distribution during a fusing process.

To solidify or fuse the build material 202 to a structural component 210 (e.g., a solid structure), the controller 104 causes the energy source 120 (e.g., infrared light) to heat (e.g., pass over) the build material 202. As the energy source provides energy (e.g., heat) to the build material 202, the fusing agent 204 absorbs the energy (e.g., heat) and distributes the energy (e.g., heat) evenly to portions of the build material 202 that includes the fusing agent 204 and/or the detailing agent 206. Thus, the fusing agent 204 enhances fusion or solidification of the build material 202. The detailing agent 206, on the contrary, reflects heat from the energy source 120 and does not allow the build material 202 to solidify or fuse, thereby facilitating removal of the 3D printed mold 102 from the support bed 114. In some examples, as noted above, the detailing agent 206 can be provided on the fusing agent 204 to improve energy distribution across the fusing agent 204 and/or the build material 202.

After the first layer 122a of the 3D printed mold 102 is formed, the second layer 122b of the 3D printed mold 102 is formed. For example, after formation of the first layer 122a, the controller 104 causes the build material dispenser 112 to deposit the build material 202 on the first layer 122a and causes the fusing agent dispenser 116 to dispense the fusing agent 204 on the build material 202 of the second layer 122b that is to molten or solidify. The energy source 120 applies energy to the build material 202, and the build material 202 solidifies at locations that includes the fusing agent 204 to form the second layer 122b of the 3D printed mold 102. The process repeats to form the plurality of layers 122 until formation of the 3D printed mold 102 is completed.

To define a porosity of the 3D printed mold 102, the controller 104 varies or controls at least one of an amount of the fusing agent 204, the detailing agent 206 or energy level, and/or a combination thereof, during formation of the 3D printed mold 102. Thus, to provide the first layer 122a, the second layer 122b, etc. (e.g., and, thus, the plurality of layers 122 and 3D printed mold 102) with a porosity based on the target porosity, at least one of the fusing agent 204, the detailing agent 206 and/or the energy level is varied during manufacturing (e.g., printing) of the 3D printed mold 102.

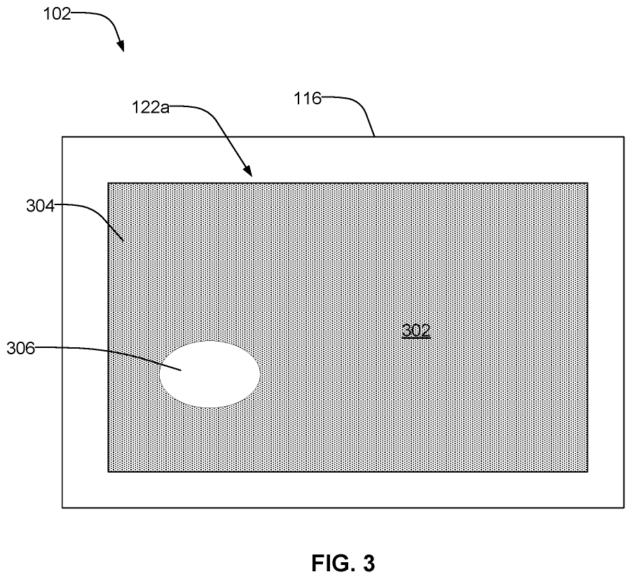

FIG. 3 is a plan view of the first layer 122a of the 3D printed mold 102 of FIGS. 1 and 2. The first layer 122a of the 3D printed mold 102 of the illustrated example is produced with a porosity that is between 2% and 45% (e.g., 20 percent, 30 percent, etc.) based on the target porosity (25%) and greater than a porosity of a fully-fused 3D printed mold (e.g., fully-fused 3D printed mold with a porosity of 0% and 2%). The porosity of a first region 302 (e.g., an entire surface area or volume) of the first layer 122a is substantially homogeneous. As used herein, “substantially homogenous” means that the porosity varies across the first region 302 of the first layer 122a by a manufacturing tolerance or variance (e.g., 10 percent variance). In other words, the porosity across the first region 302 of the first layer 122a is non-uniform (e.g., not perfectly uniform), and can vary by, for example, 10 percent relative to a target porosity. Thus, a porosity across a surface area or volume of each layer (e.g., of the plurality of layers 122) can vary within a porosity range (e.g., between approximately 20 percent and 30 percent).

Additionally, in some examples, the first layer 122a can have a first region 304 that has a porosity that is less than a porosity of a second region 306 by an amount greater than the manufacturing tolerance (e.g., greater than 10 percent). For example, the second region 306 can have a porosity between 1 percent and 10 percent, and the first region 304 can a porosity between 20 percent and 30 percent. In some such examples, the second region 306 can represent features of the 3D printed mold 102 that may require increased mechanical strength characteristic(s). For example, a wall thickness defined by the second region 306 may be smaller than a wall thickness defined by the first region 304 and, thus, may need to be formed with increased strength.

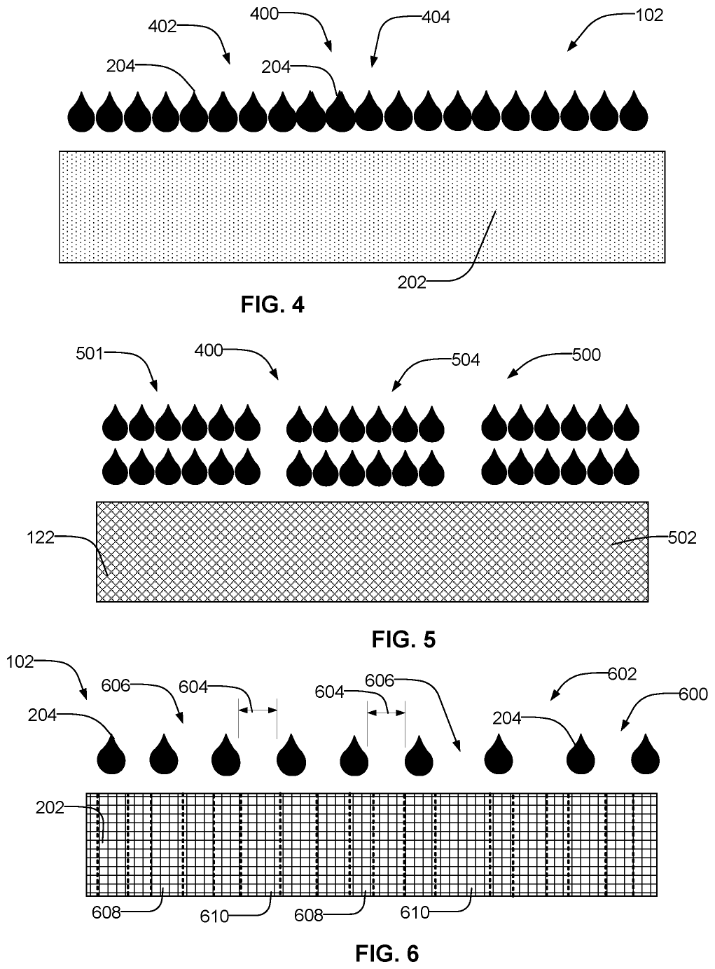

FIG. 4 is schematic illustration of an example layer 402 (e.g., the first layer 122a of FIG. 2) of the 3D printed mold 102 formed via an example contone-level control approach 400. To vary a porosity of the layer 402 of the 3D printed mold 102, the controller 104 controls a contone level of the fusing agent 204 deposited or dispensed (e.g., jetted) on the build material 202 via the fusing agent dispenser 116. For example, the layer 402 receives a first amount 404 of the fusing agent 204 associated with a first target porosity (e.g., 25 percent porosity) that is received by the controller 104. Varying an amount of at least one of the fusing agent 204, the detailing agent 206 and/or an energy level (e.g., heat) effects a degree of fusion of the build material 202 (e.g., a powder) and, thus, a porosity. For example, the first amount 404 of the fusing agent 204 is such that the fusing agent 204 causes the layer 402 to partially fuse (e.g., an under-fused layer). By way of example, a larger amount of the fusing agent 204 would be needed to form a fully-fused layer with a lower percentage porosity. Controlling the amount of the fusing agent 204 controls an absorption rate of energy or heat from the energy source 120. As a result, using a lesser amount of the fusing agent 204 enables a smaller amount of the build material 202 to become molten and solidify. As a result, the layer 402 solidifies with the porosity associated with the target porosity received by the controller 104 (within a manufacturing tolerance of the target porosity). The porosity of the layer 402 affects the resulting material properties of the layer 402 including, but not limited to, for example, Young's modulus, ultimate strain and stress, etc. In some examples, an amount of the detailing agent 206 can be provided on at least one or more portions of the fusing agent 204 and/or the layer 402 to control distribution of energy relative to the build material 202 to cause the build material 202 to solidify with the porosity associated with the target porosity. In some examples, an amount of energy from the energy source 120 can be varied to cause the build material 202 to solidity with the porosity associated with the target porosity.

FIG. 5 illustrates another example layer 500 of another example 3D printed mold 501 that includes a porosity that is different than the porosity of the layer 402 of FIG. 4. Referring to FIG. 4, for example, the first amount 404 of the fusing agent 204 is employed to form the layer 402 with a 30% porosity. As shown in FIG. 5, a second amount 504 of the fusing agent 204 different than (e.g., more than) the first amount 404 is used to form the layer 500 with a different porosity (e.g., a lesser porosity) compared to the porosity of the layer 402 of FIG. 4. For example, the porosity of the layer 502 of FIG. 5 is 20%.

The contone-level control approach 400 is also applicable during a 3D binder jetting process. For example, a contone-level of the binder agent can be controlled to vary a porosity of a 3D printed mold formed via a 3D binder jetting process.

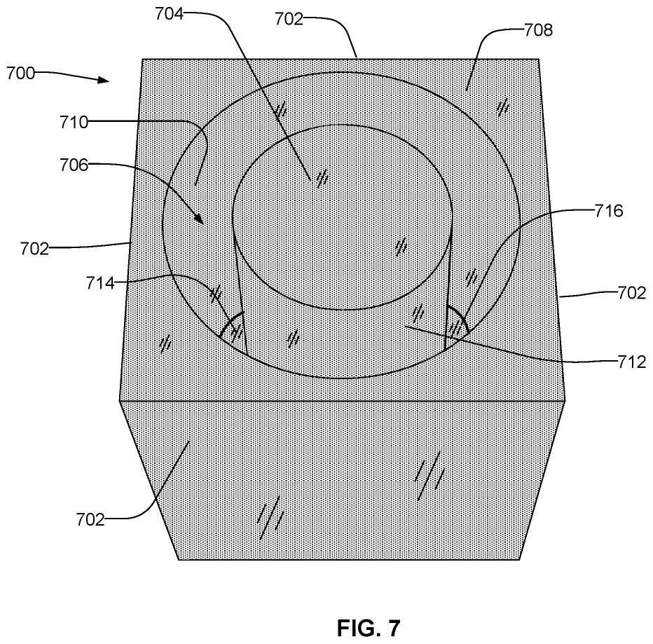

FIG. 6 is schematic illustration of an example layer 602 (e.g., the first layer 122a of FIG. 1) of the 3D printed mold 102 formed via an example heat transfer control approach 600. To control a porosity of the layer 602 of the 3D printed mold 102, the fusing agent 204 is disbursed across the layer 602 at various gaps 604. A distance 606 between the respective gaps 604 can be identical or can be different. After the fusing agent 204 is provided on layer 602, the controller 104 causes the energy source 120 to provide energy or heat to the build material 202. The heat from the energy source 120 is absorbed by the fusing agent 204 to cause the build material 202 to molten and, thus, solidify. Additionally, heat from the first regions 608 (e.g., having the fusing agent 204) transfers to adjacent second regions 610 (e.g., without the fusing agent 204). Thermal bleed from the first regions 608 causes the build material 202 of the second regions 610 to increase in temperature. As a result, the heat transfer from the first regions 608 to the second regions 610 causes the build material 202 of the second regions 610 to partially molten and solidify (e.g., after cooling). The distances 606 between the gaps 604 controls an amount or level of porosity of the layer 602. For example, although the first regions 608 has a first porosity and the second regions 610 have a second porosity less than the first porosity, an average porosity of the layer 602 can be between 20 percent and 30 percent. The heat transfer control approach is also applicable during a SLS process. For example, a heat transfer can be controlled by varying an amount of energy (e.g., heat) provided by the energy source 120 to vary a porosity of a 3D printed mold formed via the SLS process.

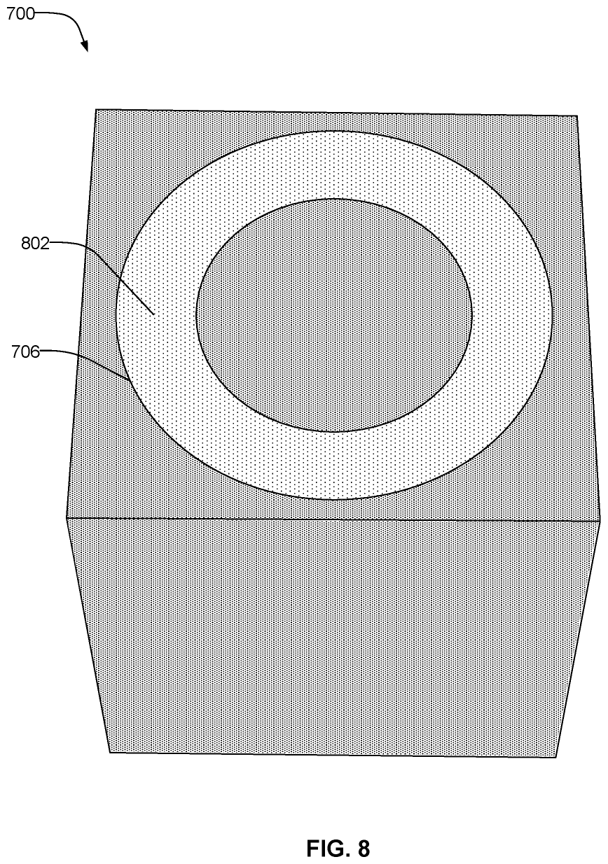

FIG. 7 is top, perspective view of an example 3D printed mold 700 that can implement the 3D printed mold 102 of FIG. 1. The 3D printed mold 700 of the illustrated example is a unitary structure that is manufactured via the workstation 100 of FIG. 1. The 3D printed mold 700 includes outer walls 702, a center post 704, a cavity 706, and an upper wall 708. The cavity 706 is defined between an inner surface 710 defined by the outer walls 702, an outer surface 712 of the center post 704, and a base 714. The base 714 defines a bottom surface 716 of the cavity 706. The 3D printed mold 700 of the illustrated example has a porosity between 20% to 30%. Although the 3D printed mold 700 has a porosity that is greater than a fully-fused 3D printed mold (e.g., a 3D printed mold that has between zero percent and five percent porosity), thicknesses (e.g., wall thicknesses) of the outer walls 702 and/or the center post 704 of the 3D printed mold 700 are substantially similar (e.g., within 1%) to thicknesses (e.g., wall thicknesses) outer walls and a center post of a 3D printed part formed via fully-fused layers providing a porosity of between 0% and 5%).

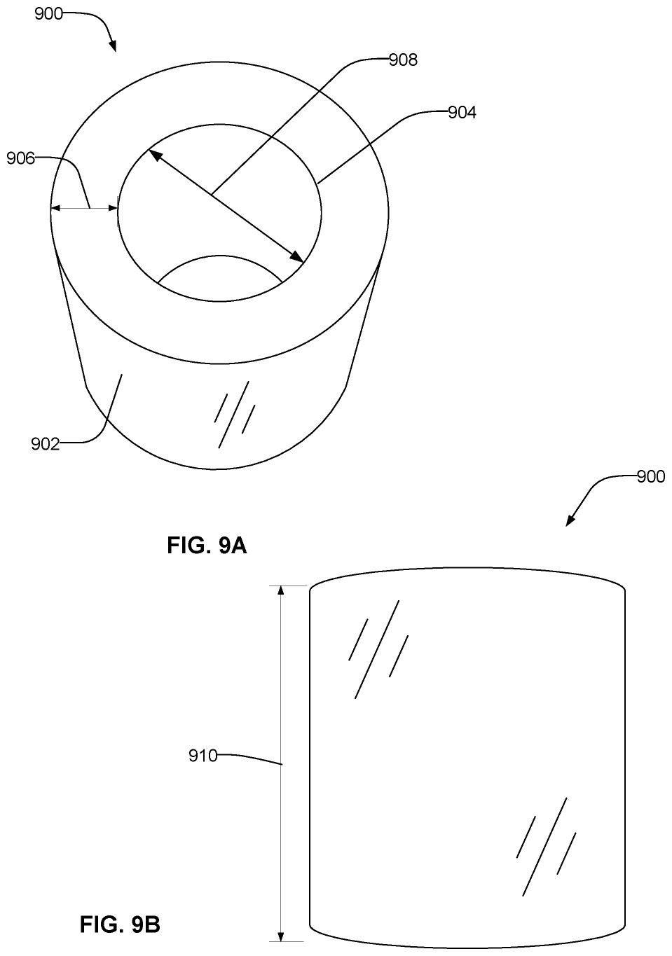

FIG. 8 is a top, perspective view of the 3D printed mold 700 of FIG. 7. To form a molded part, a moldable material 802 (e.g., ethylene-vinyl acetate (EVA) copolymer) is disposed or injected in the cavity 706 of the 3D printed mold 700. After the moldable material 802 solidifies, the moldable material 802 forms a molded part such as, for example, a molded part 900 shown in FIGS. 9A and 9B.

FIGS. 9A and 9B illustrate an example molded part 900 formed by the 3D printed mold 700 of FIG. 7. The 3D printed mold 700 of the illustrated example can be used to mold the molded part 900 via other manufacturing processes (e.g., casting). The molded part 900 of the illustrated example is a non-3D printable material. For example, the molded part 900 is composed of a material that cannot be used to build the molded part 900 via the workstation 100 of FIG. 1. The material of the molded part 900 of the illustrated example is ethylene-vinyl acetate (EVA) copolymer. EVA is an elastomeric polymer that has rubber or elastomeric characteristics in stiffness and flexibility. The material has good clarity and gloss, low-temperature toughness, stress-crack resistance, hot-melt adhesive waterproof properties, and resistance to UV radiation. EVA has wide applications and commodities (e.g., shoes, foams) and biomedical engineering (e.g., drug delivery devices). Forming the molded part 900 without use of the 3D printed mold 700 increases production timing and/or manufacturing costs. The example 3D printed mold 700 of the illustrated example enables rapid prototyping fabrication at significantly less manufacturing costs.

The molded part 900 of the illustrated example is a cylinder. The molded part 900 includes a cylindrical body 902 having an opening 904. The cylindrical body 902 is formed by the cavity 706 of the 3D printed mold 700 and the opening 904 is defined by the center post 704. For example, a distance between the inner surface 710 of the outer walls 702 and the outer surface 712 of the center post 704 defines a thickness 906 of the molded part 900 and an outer diameter of the center post 704 defines a diameter 908 of the opening 904. A length between the base 714 and the upper wall 708 defines a length 910 of the molded part 900.

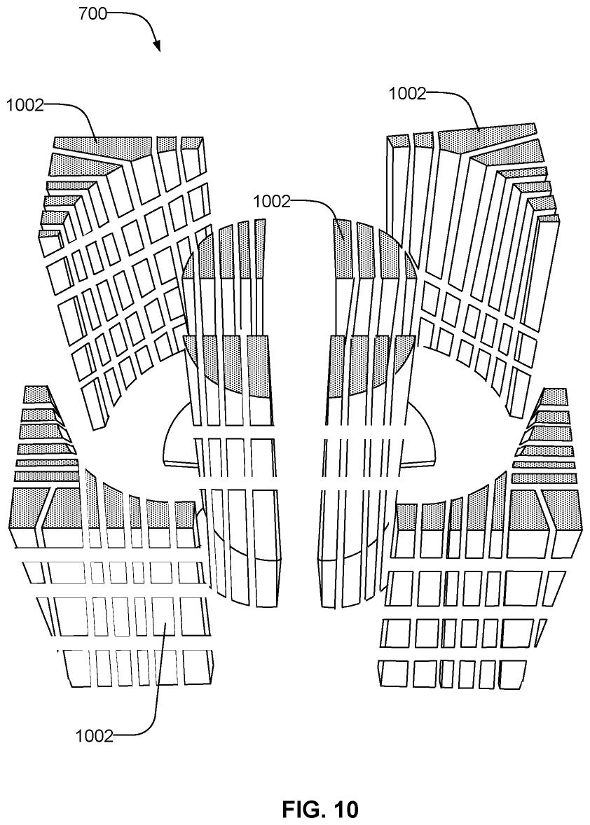

FIG. 10 illustrates the 3D printed mold 700 separated into a plurality of segments 1002. After formation of the molded part 900, the 3D printed mold 700 is removed or detached from the molded part 900 by breaking the 3D printed mold 700 into the segments 1002 via the breakaway feature defined by porosity of the 3D printed mold 700. To separate the 3D printed mold 700 into the plurality of segments 1002, the 3D printed mold 700 can be separated by an impact or force. For example, after formation of the molded part 900, the 3D printed mold 700 can be separated into the segments 1002 by applying a force or an impact to the outer walls 702 via a tool such as, for example, a hammer and a chisel. After the 3D printed mold 700 is separated into the segments 1002, the molded part 900 is extracted or removed (e.g., detached) from the 3D printed mold 700. Thus, the 3D printed mold 700 of the illustrated example is a one-time use mold. Though FIG. 10 shows the 3D printed mold 700 separated into different groups of segments of uniform shapes or sizes separated by linear and/or smooth edges, the 3D printed mold 700 can be separated into any number of different parts or segments having the same, similar and/or irregular sizes and shapes, and/or non-smooth edges.

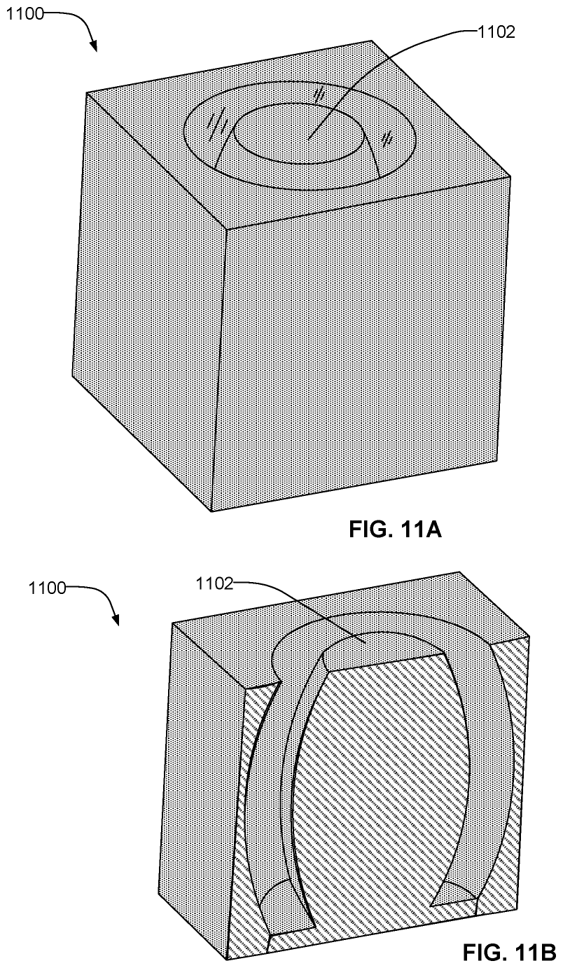

FIG. 11A is a top, perspective view of another example 3D printed mold 1100 that can implement the 3D printed mold 102 of FIG. 1. FIG. 11B is a cross-sectional view of the 3D printed mold 1100 of FIG. 11A. The 3D printed mold 1100 of the illustrated example is a unitary structure manufactured via the workstation 100 of FIG. 1. The 3D printed mold 1100 includes a barrel shaped center core 1102 compared to a cylindrical shaped center post 704 of FIG. 7.

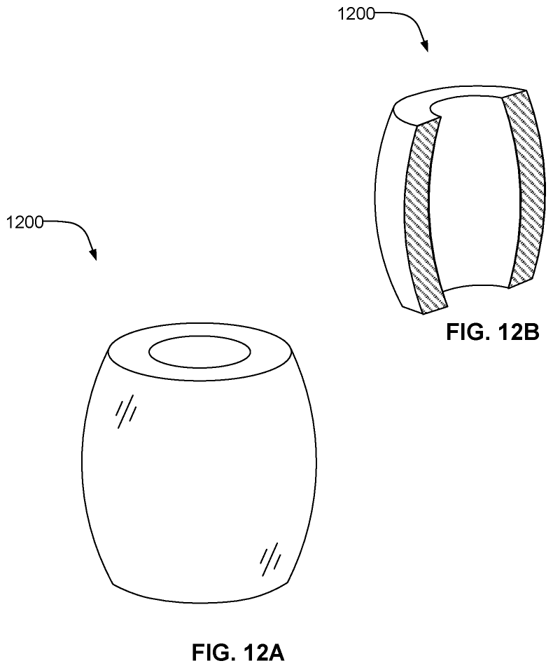

FIG. 12A is an example molded part 1200 formed (e.g., via casting) using the 3D printed mold 1100 of FIGS. 11A and 11B. FIG. 12B is a cross-sectional view of the molded part 1200. The molded part 1200 of the illustrated example is a barrel. The molded part 1200, due to its geometry, cannot be manufactured by traditional molding or casting process because a mold core (e.g., the core 1102) in the middle of the barrel cannot be separated from the barrel after the manufacturing process. When a material is not 3D-printable, a molded part may be machined (e.g., via Computer Numeric Control (CNC) machine), which can be expensive and time-consuming. The 3D printed mold 1100 of the illustrated example includes a complex geometry that can be formed via 3D printable material(s) using the workstation 100 of FIG. 1 and, after formation, can be used to form the molded part 1200 using non-3D printable material(s) (e.g., plastic material(s), metallic material(s), etc.).

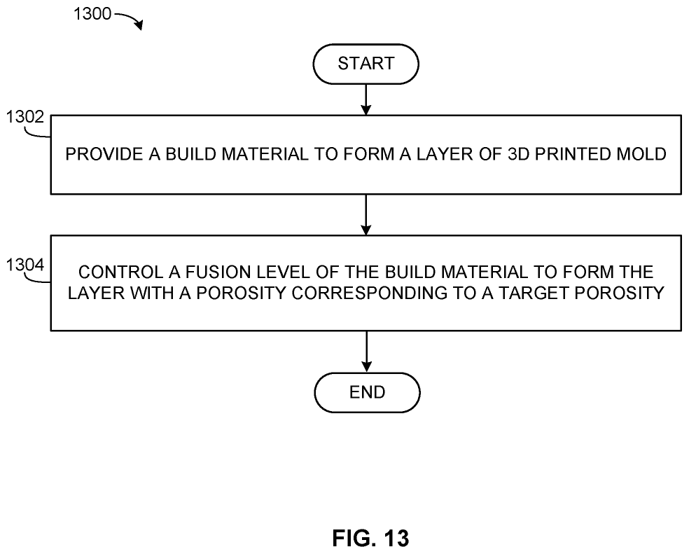

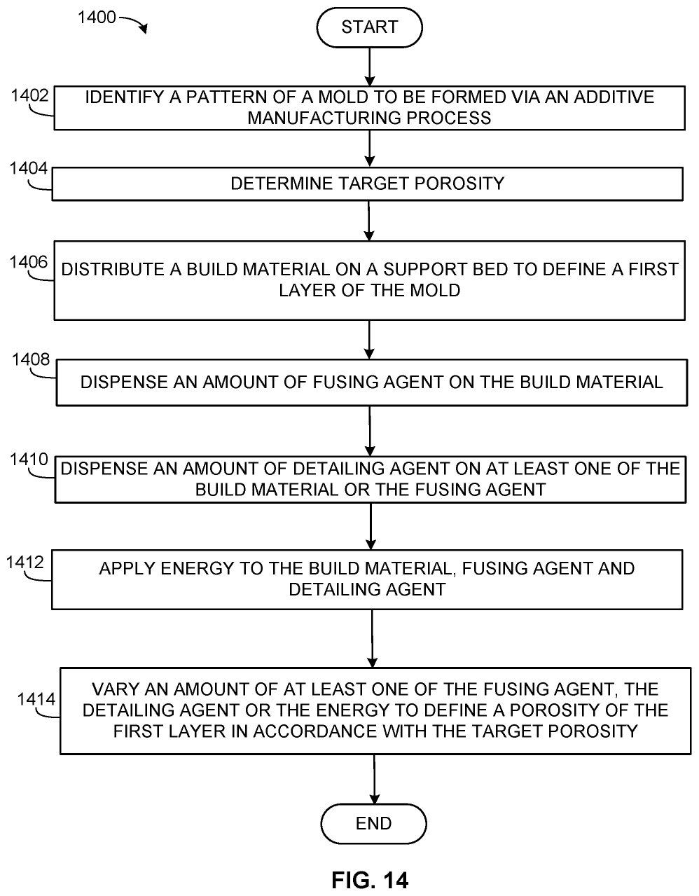

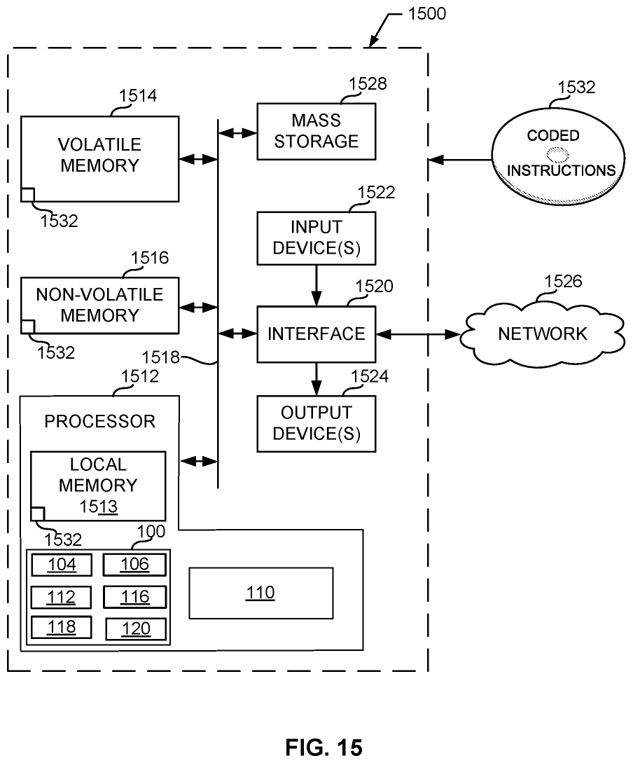

FIGS. 13-14 are example flowcharts representative of example methods 1300-1400 for manufacturing 3D printed molds (e.g., the 3D printed molds 102, 700, 1100) disclosed herein. In some examples, the blocks or processes can be re-arranged or removed, or additional blocks can be added. The example methods 1300-1400 of FIGS. 13-14 may be implemented by the example controller 104, the example printer 106, the example build material dispenser 112, the example fusing agent dispenser 116, the example detailing agent dispenser 118, the example energy source 120 and/or, more generally, the example workstation 100 of FIG. 1. In some examples, the flowcharts of FIGS. 13-14 may be representative of example hardware logic, machine readable instructions, hardware implemented state machines, and/or any combination thereof for implementing the example controller 104, the example printer 106, the example build material dispenser 112, the example fusing agent dispenser 116, the example detailing agent dispenser 118, the example energy source 120 and/or, more generally, the example workstation 100 of FIG. 1. In this example, the machine readable instructions may be an executable program or portion of an executable program for execution by a computer processor such as the computing device 110 and/or the processor 1512 shown in the example processor platform 1500 discussed in connection with FIG. 15. The program may be embodied in software (e.g., machine readable instructions) stored on a non-transitory computer readable storage medium such as a CD-ROM, a floppy disk, a hard drive, a DVD, a Blu-ray disk, or a memory associated with the processor 1512, but the entire program and/or parts thereof could alternatively be executed by a device other than the processor 1512 and/or embodied in firmware or dedicated hardware. Further, although the example programs are described with reference to the methods 1300-1400 illustrated in the flowcharts of FIGS. 13-14, many other methods of implementing the example controller 104, the example printer 106, the example build material dispenser 112, the example fusing agent dispenser 116, the example detailing agent dispenser 118, the example energy source 120 and/or, more generally, the example workstation 100 of FIG. 1 may alternatively be used. For example, the order of execution of the blocks may be changed, and/or some of the blocks described may be changed, eliminated, or combined. Additionally or alternatively, any or all of the blocks may be implemented by hardware circuit(s) (e.g., discrete and/or integrated analog and/or digital circuitry, an FPGA, an ASIC, a comparator, an operational-amplifier (op-amp), a logic circuit, etc.) structured to perform the corresponding operation without executing software or firmware (e.g., machine readable instructions).

As mentioned herein, the example processes of FIGS. 13-14 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C.

The example method 1300 of FIG. 13 begins by providing a build material 202 to form a first layer 122a of the 3D printed mold 102, 700, 1100 (block 1302). For example, the build material dispenser 112 dispenses the build material 202 on the support bed 114 of the workstation 100 and/or the printer 106 for each of the layers 122. After the build material 202 is dispensed on the support bed 114, the controller 104 controls a fusion level of the build material to form the first layer 122a with a porosity corresponding to a target porosity (block 1304). For example, the controlling the fusion level can increase the porosity of the first layer 122a of the 3D printed mold. For example, to vary a porosity in connection with the contone-level control approach 400 of the MJF process, the controller 104 causes the fusing agent dispenser 116 to dispense the first amount 404 of fusing agent 204 on the build material 202 associated with the target porosity. For example, in connection with the heat transfer control approach 600 of the MJF process, the controller 104 causes the fusing agent dispenser 116 to dispense an amount of fusing agent 204 on the build material 202 with various gaps 604. For example, to vary a porosity in connection with a detailing agent approach, the workstation 100 of FIG. 1 can be configured to dispense a detailing agent (e.g., water) to control a temperature of the build material. For example, to vary a porosity of a 3D printed mold 102 in connection with a SLS process, the controller 104 can command the energy source 120 to vary an amount of energy provided to the build material. For example, to vary a porosity of a 3D printed mold 102 in connection with a 3D binder jetting process, the controller 104 can vary at least one of a binder agent provided to a build material or an amount of energy provided to the binder agent and the build material.

Referring to FIG. 14, the method 1400 includes identifying a pattern of a mold (e.g., the 3D printed mold 102) to be formed via an additive manufacturing process 200 (block 1402). In some examples, the workstation 100 receives the digital file representative of the 3D printed mold 102.The controller 104 determines a pattern representative of the 3D printed mold 102 based on the digital image.

The controller 104 determines a target porosity for the 3D printed mold (block 1404). For example, the controller 104 can obtain the target porosity from the digital file of the 3D printed mold 102. In some examples, the controller 104 receives or obtains the target porosity via an input (e.g., a user input at the printer 106 and/or via the example network 108).

The controller 104 of the illustrated example causes the build material dispenser 112 to distribute the build material 202 on the support bed 114 to define a first layer 122a of the 3D printed mold 102 (block 1406).

The controller 104 of the illustrated example causes the fusing agent dispenser 116 to dispense a first amount 404 of the fusing agent 204 on the build material 202 to define a porosity of the first layer 122a of the 3D printed mold 102 in accordance with the target porosity (block 1408). In some examples, the controller 104 can cause the fusing agent dispenser 116 to dispense a second amount of the fusing agent 204 on a second portion of the first layer 122a of the build material 202 to define a second region 306 of the first layer 122a of the 3D printed mold 102, where the first amount 404 is different than (e.g., less than) the second amount 504.

To controller 104 of the illustrated example causes the detailing agent dispenser 118 to dispense a second amount of the detailing agent 206 on at least one of the build material 202 or the fusing agent 204 (block 1410).

To solidify the first layer 122a of the 3D printed mold 102, the controller 104 causes the energy source 120 to apply energy (e.g., heat) to the first layer 122a of the build material 202, the fusing agent 204 and the detailing agent 206 (block 1412). The energy provided by the energy source 120 is to cause the build material 202 to molten and solidify into the first layer 122a of the 3D printed mold 102 after cooling.

To define a porosity of the first layer 122a (e.g., the 3D printed mold 102), the controller 104 of the illustrated example varies the amount of at least one of the fusing agent 204, the detailing agent 206, or the energy (block 1414). For example, the controller 104 determines (e.g., calculates) the amount and/or location of the fusing agent 204, the detailing agent 206 and/or the build material 202 based on a pattern of the 3D printed mold 102 (e.g., from the digital file) and the determined target porosity, and operates the build material dispenser 112 and/or the fusing agent dispenser 116 to dispense such determined amounts. In some examples, the controller 104 can control the energy source 120 to generate an amount of heat needed to solidify the first layer 122a (e.g., the layers 122) with a porosity associated with the target porosity. For example, the controller 104 can vary amounts of the fusing agent 204, the detailing agent 206, and/or the energy level to enable the first layer 122a to achieve a porosity of between 20 percent and 30 percent based on the target porosity value of approximately 25%. The process is repeated until all layers 122 defining the 3D printed mold 102 are complete.

FIG. 15 is a block diagram of an example processor platform 1500 structured to execute the instructions of the example processes of FIGS. 13-14 to implement the example controller 104, the example printer 106, the example build material dispenser 112, the example fusing agent dispenser 116, the detailing agent dispenser 118, the example energy source 120 and/or, more generally, the example workstation 100 of FIG. 1. The processor platform 1500 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, or any other type of computing device.

The processor platform 1500 of the illustrated example includes a processor 1512. The processor 1512 of the illustrated example is hardware. For example, the processor 1512 can be implemented by integrated circuit(s), logic circuit(s), microprocessor(s), GPU(s), DSP(s), or controller(s) from any desired family or manufacturer. The hardware processor may be a semiconductor based (e.g., silicon based) device. In this example, the processor implements aspect(s) of the example controller 104, the example printer 106, the example build material dispenser 112, the example fusing agent dispenser 116, the detailing agent dispenser 118, the example energy source 120 and/or, more generally, the example workstation 100 of FIG. 1.

The processor 1512 of the illustrated example includes a local memory 1513 (e.g., a cache). The processor 1512 of the illustrated example is in communication with a main memory including a volatile memory 1514 and a non-volatile memory 1516 via a bus 1518. The volatile memory 1514 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 1516 may be implemented by flash memory and/or any other desired type of memory device. Access to the main memory 1514, 1516 is controlled by a memory controller.

The processor platform 1500 of the illustrated example also includes an interface circuit 1520. The interface circuit 1520 may be implemented by any type of interface standard, such as an Ethernet interface, a universal serial bus (USB), a Bluetooth® interface, a near field communication (NFC) interface, and/or a PCI express interface.

In the illustrated example, input device(s) 1522 are connected to the interface circuit 1520. The input device(s) 1522 perm it(s) a user to enter data and/or commands into the processor 1512. The input device(s) can be implemented by, for example, an audio sensor, a microphone, a camera (still or video), a keyboard, a button, a mouse, a touchscreen, a track-pad, a trackball, isopoint, and/or a voice recognition system. For example, the input device(s) 1522 can receive a target porosity value.

Output device(s) 1524 are also connected to the interface circuit 1520 of the illustrated example. The output devices 1524 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer, and/or speaker. The interface circuit 1520 of the illustrated example includes a graphics driver card, a graphics driver chip and/or a graphics driver processor.

The interface circuit 1520 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 1526. The communication can be via, for example, an Ethernet connection, a digital subscriber line (DSL) connection, a telephone line connection, a coaxial cable system, a satellite system, a line-of-site wireless system, a cellular telephone system, etc.

The processor platform 1500 of the illustrated example also includes mass storage device(s) 1528 for storing software (e.g., machine readable instructions) and/or data. Examples of such mass storage devices 1528 include floppy disk drives, hard drive disks, compact disk drives, Blu-ray disk drives, redundant array of independent disks (RAID) systems, and digital versatile disk (DVD) drives.

The machine executable instructions 1532 of FIGS. 13-14 may be stored in the mass storage device 1528, in the volatile memory 1514, in the non-volatile memory 1516, and/or on a removable non-transitory computer readable storage medium such as a CD or DVD.

The example methods, apparatus, systems, and articles of manufacture disclosed herein provide breakaway features for easy mold breakdown and removal. The breakaway features are formed by portions of the mold that are relatively weakly connected or coupled to stronger portions of the mold. A strength (e.g., or weakness) of the breakaway features can be varied during printing of the 3D printed mold. As a result, the mold has strength to withstand handling and maintain its shape during a molding process. Meanwhile, the mold can be broken down easily after a molded part is formed using the mold. The example 3D printed molds disclosed herein can be formed with higher geometric accuracy or precision than forming a mold using other manufacturing processes (e.g., machining).

At least some of the aforementioned examples include at least one feature and/or benefit including, but not limited to, the following:

In some examples, a method for forming a mold having a cavity by creating a plurality of layers using an additive manufacturing process includes: providing a build material; and controlling a fusion level of the build material separately for different layers of the plurality of layers to separately form the layers with a porosity corresponding to a target porosity.

In some examples, the controlling of the fusion level includes controlling a contone level of at least one of a fusing agent or a detailing agent.

In some examples, the controlling of the fusion level includes controlling a heat transfer.

In some examples, the controlling of the fusion level includes varying at least one of a binder agent or an energy level provided to the build material.

In some examples, the controlling of the fusion level includes controlling an energy level provided to the build material.

In some examples, the controlling of the fusion level includes providing a detailing agent to the build material.

In some examples, controlling the fusion level enables a porosity of the layer to between approximately 2 percent and 45 percent.

In some examples, after formation of the mold, the method further includes: providing a moldable material in the cavity of the mold to form a molded part; and removing the mold from the mold part by breaking the mold from the molded part via a breakaway feature defined by the porosity of the mold.

In some examples, the controlling of the fusion level includes: identifying a pattern of the mold to be formed via the additive manufacturing process; distributing the build material on a support bed to define a first layer of the mold in accordance with the pattern; dispensing a first amount of fusing agent on the build material; dispensing a second amount of detailing agent on at least a portion of the build material or the fusing agent; and applying an energy to the build material and fusing agent to solidify the first layer, and defining the porosity of the first layer in accordance with the target porosity, by varying at least one of: the first amount of the fusing agent; the second amount of the detailing agent; or the amount of the energy.

In some examples, a tangible computer readable storage medium comprising instructions which, when executed, cause a processor to at least: receive an image representative of a 3D printed mold; determine a target porosity of the 3D printed mold; and for individual layers of the 3D printed mold: determine an amount of build material to be dispensed by a build material dispenser of a 3D printer; and define a porosity of the individual layers in accordance with the target porosity, by determining at least one of: a first amount of a fusing agent to be dispensed by a fusing agent dispenser of the 3D printer; a second amount of detailing agent to be dispensed by a detailing agent dispenser of the 3D printer on at least a portion of the build material or the fusing agent; or an amount of energy to be applied to the build material, the fusing agent and the detailing agent, via an energy source of the 3D printer.

In some examples, the instructions, when executed, cause the processor to instruct the fusing agent dispenser to dispense the determined first amount of the fusing agent, instruct the detailing agent dispenser to dispense the determined second amount of detailing agent, and instruct the energy source to apply the determined amount of energy to the build material, the fusing agent and the detailing agent.

In some examples, a method for forming a mold having a cavity by creating a plurality of layers using an additive manufacturing process includes: identifying a pattern of a mold to be formed via an additive manufacturing process; determining a target porosity; distributing a build material on a support bed to define a first layer of the mold; dispensing a first amount of fusing agent on the build material; dispensing a second amount of detailing agent on at least a portion of the build material or the fusing agent; and applying, via an energy source, an energy to the build material and fusing agent to solidify the first layer; where the dispensing of the first amount of suing agent, the second amount of the detailing agent or the applying of the energy includes varying at least one of the first amount of the fusing agent, the second amount of the detailing agent, or a third amount of the energy to define a first porosity of the first layer in accordance with the target porosity.

In some examples, the method further includes distributing the build material on the first layer of the mold to define a second layer of the mold; dispensing the first amount of the fusing agent on the build material of the second layer of the mold in accordance with the target porosity; and applying energy, via an energy source, to the fusing agent to fuse the build material and solidify the second layer of the mold, the second layer having the first porosity.

In some examples, the method includes distributing the build material on the first layer of the mold to define a second layer of the mold; dispensing a fourth amount of the fusing agent on the build material of the second layer of the mold; dispensing a fifth amount of the detailing agent on at least one of the build material or the fusing agent; applying energy, via an energy source, to the fusing agent to fuse the build material and solidify the second layer of the mold; and varying at least one of the fourth amount of the fusing agent, the fifth amount of the detailing agent, or a sixth amount of the energy to define a second porosity of the second layer in accordance with the target porosity.

In some examples, a workstation for printing a 3D printed mold via a plurality of layers includes: a build material dispenser to dispense a build material on a support bed; a fusing agent dispenser to dispense a fusing agent on the build material; and a controller to: receive a print command representative of the 3D printed mold; determine a target porosity of the 3D printed mold; and for individual layers of the 3D printed mold: cause the build material dispenser to dispense the build material; cause the fusing agent dispenser to dispense an amount of the fusing agent on the build material, the amount of the fusing agent corresponding to the target porosity; and control an energy source to apply energy to the build material and the fusing agent to form the individual layers with a porosity that is based on the target porosity.

In some examples, the amount of the fusing agent is to cause the individual layers of the 3D printed mold to form as an under-fused powder layer.

In some examples, the porosity across a surface area or volume of the individual layers varies within a porosity range.

In some examples, the porosity range is between approximately 2 percent and 45 percent.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

1. A method for forming a mold having a cavity by creating a plurality of layers using an additive manufacturing process, the method comprising:
providing a build material; and
controlling a fusion level of the build material separately for different layers of the plurality of layers to separately form the layers with a porosity corresponding to a target porosity.

2. The method of claim 1, wherein the controlling of the fusion level includes controlling a contone level of at least one of a fusing agent or a detailing agent.

3. The method of claim 1, wherein the controlling of the fusion level includes controlling a heat transfer.

4. The method of claim 1, wherein the controlling of the fusion level includes varying at least one of a binder agent or an energy level provided to the build material.

5. The method of claim 1, wherein the controlling of the fusion level includes controlling an energy level provided to the build material.

6. The method of claim 1, wherein the controlling of the fusion level includes providing a detailing agent to the build material.

7. The method of claim 1, wherein controlling the fusion level enables a porosity of the layer to between approximately 2 percent and 45 percent.

8. The method of claim 1, wherein after formation of the mold, further including:
providing a moldable material in the cavity of the mold to form a molded part; and
removing the mold from the mold part by breaking the mold from the molded part via a breakaway feature defined by the porosity of the mold.

9. The method of claim 1, wherein the controlling of the fusion level includes:
identifying a pattern of the mold to be formed via the additive manufacturing process;
distributing the build material on a support bed to define a first layer of the mold in accordance with the pattern;
dispensing a first amount of fusing agent on the build material;
dispensing a second amount of detailing agent on at least a portion of the build material or the fusing agent; and
applying an energy to the build material and fusing agent to solidify the first layer; and
defining the porosity of the first layer in accordance with the target porosity by varying at least one of: the first amount of the fusing agent; the second amount of the detailing agent; or the amount of the energy.

10. A tangible computer readable storage medium comprising instructions which, when executed, cause a processor to at least:
receive an image representative of a 3D printed mold; and
determine a target porosity of the 3D printed mold;
for individual layers of the 3D printed mold:
determine an amount of build material to be dispensed by a build material dispenser of a 3D printer; and
define a porosity of the individual layers in accordance with the target porosity, by determining at least one of:
a first amount of a fusing agent to be dispensed by a fusing agent dispenser of the 3D printer;
a second amount of detailing agent to be dispensed by a detailing agent dispenser of the 3D printer on at least a portion of the build material or the fusing agent; or
an amount of energy to be applied to the build material, the fusing agent and the detailing agent, via an energy source of the 3D printer.

11. The computer readable storage medium as defined in claim 10 wherein the instructions, when executed, cause the processor to instruct the fusing agent dispenser to dispense the determined first amount of the fusing agent, instruct the detailing agent dispenser to dispense the determined second amount of detailing agent, and instruct the energy source to apply the determined amount of energy to the build material, the fusing agent and the detailing agent.

12. A workstation for printing a 3D printed mold via a plurality of layers, the workstation comprising:
a build material dispenser to dispense a build material on a support bed;
a fusing agent dispenser to dispense a fusing agent on the build material; and
a controller to:
receive a print command representative of the 3D printed mold;
determine a target porosity of the 3D printed mold; and
for individual layers of the 3D printed mold:
cause the build material dispenser to dispense the build material;
cause the fusing agent dispenser to dispense an amount of the fusing agent on the build material, the amount of the fusing agent corresponding to the target porosity; and
control an energy source to apply energy to the build material and the fusing agent to form the individual layers with a porosity that is based on the target porosity.

13. The workstation of claim 12, wherein the amount of the fusing agent is to cause the individual layers of the 3D printed mold to form as an under-fused powder layer.

14. The workstation of claim 12, wherein the porosity across a surface area or volume of the individual layers varies within a porosity range.

15. The workstation of claim 14, wherein the porosity range is between approximately 2 percent and 45 percent.
